(19) United States
(12) Patent Application Publication
(10) Pub. No.: US 2011/0204624 A1
(43) Pub. Date: Aug. 25, 2011

(54) UNIVERSAL CONNECTION SOCKET

(75) Inventor: Benjamin L. Lawrence, Elkhart, IN (US)

(73) Assignee: NIBCO Inc., Elkhart, IN (US)

(21) Appl. No.: 13/027,735

(22) Filed: Feb. 15, 2011

Related U.S. Application Data
(60) Provisional application No. 61/307,988, filed on Feb. 25, 2010.

(51) Int. Cl. F16L 19/00

(52) U.S. Cl. 285/345

(57) ABSTRACT

A universal connection socket includes in one embodiment a plurality of spaced radially inwardly projecting barbs spanning opposite sides of a circumferential O-ring receiving groove and dimensioned to grip, when crimped, a fluid conduit in sealable engagement within the socket. In another embodiment of the invention, an annular recess adjacent the O-ring groove releasably receives a locking sleeve for a push-type connector for compressing the O-ring during insertion of a conduit. The sleeve is subsequently partially withdrawn and has an inwardly extending locking barb to engage the conduit, lockably holding the conduit in place. An outwardly extending gripping edge cams the locking barb as a locking wedge is inserted between the end of the socket and the annular flange of the sleeve.

### CROSS-REFERENCE TO RELATED APPLICATIONS

This application claims priority under 35 U.S.C. §119(e) and the benefit of U.S. Provisional Application No. 61/307,988 entitled UNIVERSAL CONNECTION SOCKET, filed on Feb. 25, 2010, by Benjamin L. Lawrence, the entire disclosure of which is incorporated herein by reference.

### BACKGROUND OF THE INVENTION

The present invention relates to plumbing fittings and particularly to a fitting having a universal socket for accommodating different types of conduits and connections to the plumbing fitting.

As the plumbing industry evolves, the use of soldered copper pipe connections is becoming less prevalent in favor of more modern quick-connect either push or crimp fittings. Also, in many installations, PEX tubing is employed in favor of the previous copper tubing. Each of the different types of connections typically require different tools, skills, and connectors for fittings, such as valves, T's, elbows, and the like, to mate with the corresponding tubing be it copper, cross linked polyethylene, or other material. There exists a variety of push-type connections, crimp connections, and press connections, all of which use different types of tools and plumbing skills for making connections in a plumbing system.

One example of a new connection system is described in U.S. Patent Publication No. 2010/0171302, entitled PUSH-TWIST CONNECTOR. The system described employs a fitting which receives a push-in pipe locked in place by a connector which includes a locking ring to secure the connection.

There remains a need, however, for a universal connection system which can accommodate press joints (also known as crimp connections), PEX joints (in which plastic tubing is connected to metal fittings), and push-joints (in which no crimping is required but typically a locking member is employed).

### SUMMARY OF THE INVENTION

The universal connection socket of the present invention accommodates this need by providing a socket which can be included in any type of plumbing fitting, including, for example, valves, T's, elbows, connectors, and the like. A plumbing fitting including the universal socket of the present invention includes a plurality of spaced radially inwardly projecting barbs spanning opposite sides of a circumferential O-ring receiving groove and dimensioned to grip, when crimped, a fluid conduit in sealable engagement within the socket.

In one embodiment of the invention, an annular recess adjacent the O-ring groove of the socket receives a locking sleeve for a push-type connector for compressing the O-ring during insertion of a conduit. The sleeve is subsequently withdrawn and has an inwardly extending locking barb to engage the conduit, lockably holding the conduit in place. The locking sleeve in one embodiment includes an annular flange external to the socket which allows the sleeve to be moved to a locked position by a locking wedge inserted between the end of the socket and the annular flange of the sleeve.

In yet another embodiment of the invention, the socket is employed with a PEX fitting in which a reinforcement cylindrical metal stiffener is inserted in the end of a PEX conduit and subsequently inserted into the socket and crimped to complete the sealed connection.

In each of the embodiments, the gripping barbs secure the conduit to the socket of the fitting either directly or indirectly through an intermediate locking sleeve. In each of the embodiments, the fitting is of universal design and can be manufactured of any number of copper and copper alloys, carbon steel or stainless steel alloys or leaded brass/bronze and configured to receive a universal connection method. With such a system, the cost of manufacturing fittings, such as valves, T's, elbows, connectors, and the like can be greatly reduced since they employ common tooling, assembly techniques, and manufacturing processes for their manufacturing. Also, assembly in the field requires no special tools or plumbing skills.

These and other features, objects and advantages of the present invention will become apparent upon reading the following description thereof together with reference to the accompanying drawings.

### BRIEF DESCRIPTION OF THE DRAWINGS

FIG. 1 is a fragmentary front elevational view of a fitting employing the universal socket of the present invention;

FIG. 2 is a cross-sectional view of the fittings shown in FIG. 1, shown with a copper or other metallic conduit inserted therein prior to crimping;

FIG. 3 is a fragmentary front elevational view of the crimp sealing of the connection shown in FIG. 2;

FIG. 4 is a fragmentary cross-sectional view of the universal socket applied to a PEX connection;

FIG. 5 is an exploded top elevational view of the components of the PEX connection;

FIG. 6 is a partially assembled view of the structure shown in FIG. 5;

FIG. 7 is an assembled view of the PEX connection shown in FIG. 4-6;

FIG. 8 is a fragmentary cross-sectional view of a fitting employing a push joint connection employing the universal socket of the present invention, shown in a partially assembled position to illustrate the interaction of the components;

FIG. 9 is a fragmentary cross-sectional view of the structure shown in FIG. 8, shown in a position in which a conduit can be inserted and/or released from the fitting;

FIG. 10 is a perspective view of the locking sleeve employed in connection with the universal socket shown in FIGS. 8 and 9;

FIG. 11 is a cross-sectional view of the locking sleeve shown in FIG. 10;

FIG. 12 is a perspective exploded view of the fitting, including the universal socket, and a tapered locking wedge employed for moving the locking sleeve from an insertion position to a pipe locking position; and

FIG. 13 is a side elevational view of a fitting employing the universal socket with a conduit fully installed.

### DETAILED DESCRIPTION OF THE PREFERRED EMBODIMENT

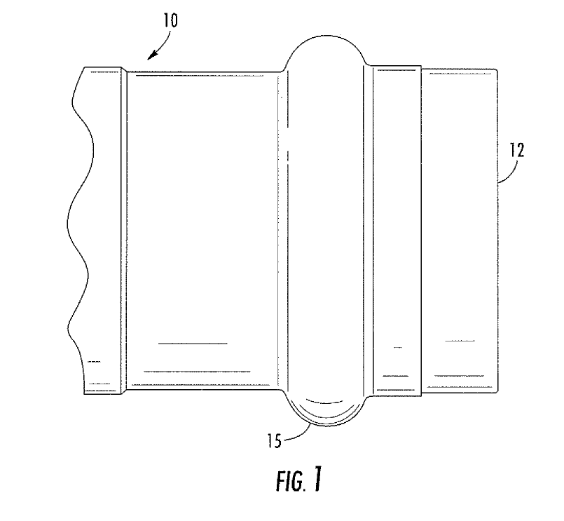

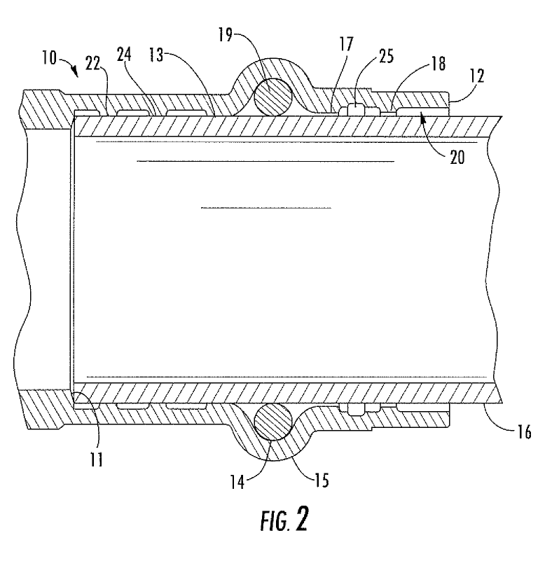

Referring initially to FIGS. 1 and 2, there is shown a press or crimp joint in which a fitting 10 includes the universal socket geometry 20 of the present invention. The fitting 10 can be any type of plumbing fitting, such as a valve, T, elbow, connector or the like, and can be made from numerous materials, which can be cast, forged, cold-formed, or machined. Such materials include, but are not limited to, the following:
Copper and Copper Alloys
   Silicon Bronze C87600, Copper C12200, Silicon Brass C69100
Carbon, Stainless and Alloyed Steels
   CS1020, SS316, SS410
Leaded Brass/Bronze
   Red Bronze C92200

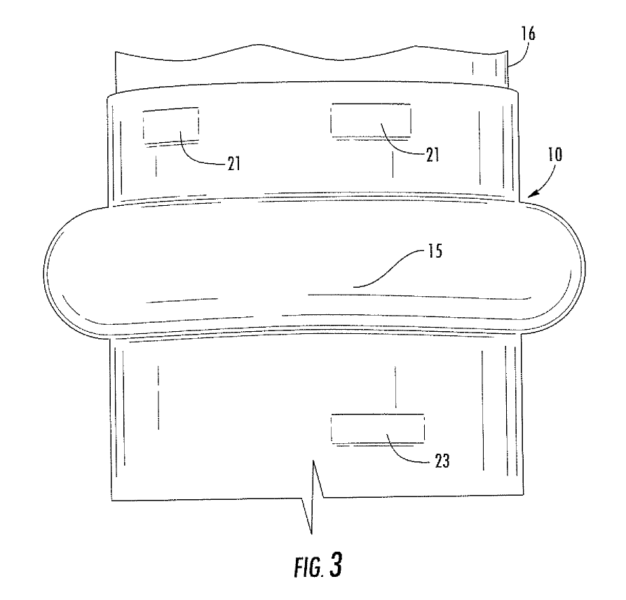

Fitting 10 includes an open end 12 and an internal annular O-ring receiving groove 14 spaced from end 12 a distance sufficient for the insertion and crimping of a tube, such as copper conduit 16 shown in FIG. 2. Extending between the annular groove 14, which forms an external bulge 15 as seen in FIG. 1, and end 12 is a first radially inwardly extending annular generally rectangular barb 18. Adjacent barb 18 is an annular stepped recess 25 which, in the first and second embodiments, does not assist in the sealed connection but forms part of the universal socket employed in the third (push) embodiment. Adjacent the edges of annular groove 14 are annular lands 13 and 17, as best seen in FIG. 2. On the opposite side of the O-ring groove 14 and an O-ring 19 inserted therein, are a pair of spaced-apart additional radially inwardly extending annular generally rectangular barbs 22 and 24. Upon insertion of the copper conduit 16 into the fitting 10, a circumferential crimping force is applied in areas indicated by arrows A and B, resulting in crimps 21 and 23 (FIG. 3) and additional crimps extending around the periphery of the cylindrical end of fitting 10.

A conventional crimping tool is employed for providing uniform crimps 21 and 23 on opposite sides of O-ring groove 14 and around the periphery of the fitting. The crimping urges barbs 18, 22, and 24 against the outer surface of conduit 16 and lockably holds the conduit 16 within fitting 10 as well as assures that the O-ring 19 seals the interface between fitting 10 and conduit 16. Each of the barbs 18, 22, and 24 are generally rectangular in cross section having relatively sharp edges and extend radially inwardly a distance of about 0.010 inches for a 0.5 inch internal diameter fitting. Depending on the internal diameter of socket 20 and mating conduit 16, other sizes will be proportional. Lands 13 and 17, as seen in FIG. 2, serve to captively hold the O-ring 19 in position against the outer surface of the conduit 16 inserted therein. Fitting 10 includes an annular stop shoulder 11 at its inner end to engage the end of conduit 16 to position the conduit 16 in predetermined relationship to fitting 10.

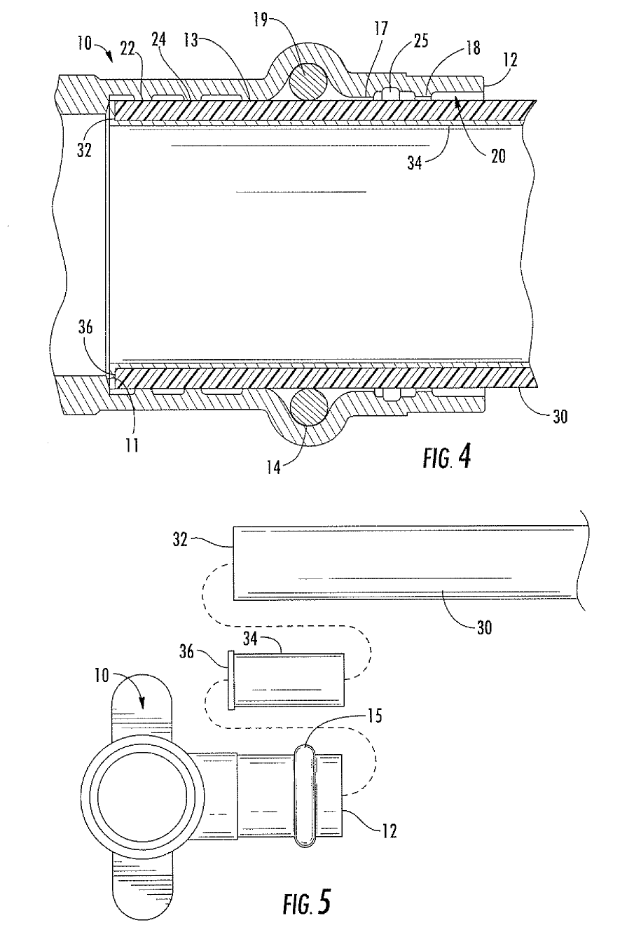

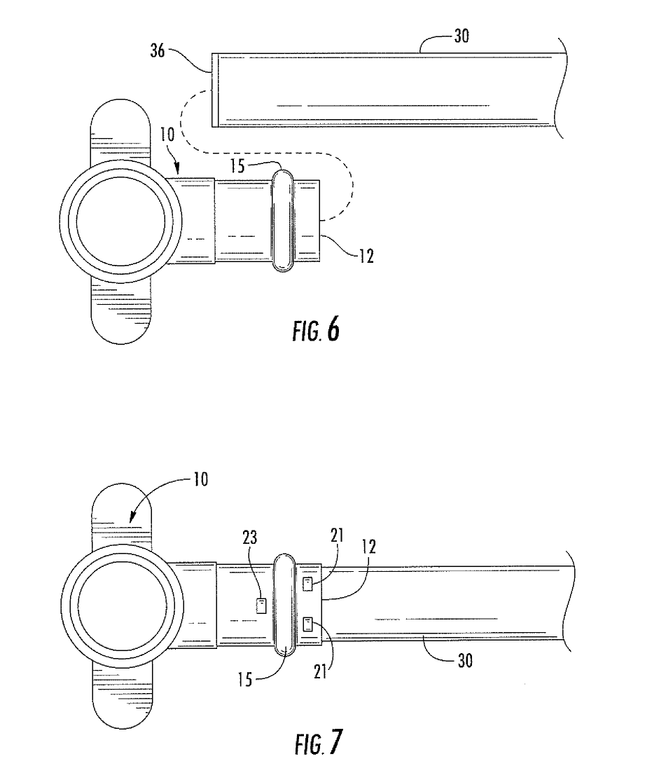

FIGS. 4-7 illustrate the use of the same fitting 10 and universal socket 20 for use in connection with a PEX tubing 30. Fitting 10 includes the same O-ring annular groove 14, external bulge 15, end 12, and rectangular barbs 18, 22, and 24, lands 13 and 17, and stop shoulder 11. In order to withstand the crimping forces applied again in areas indicated by arrows A and B in FIG. 4, a stiffener sleeve 34 made of a suitable metal, such as stainless steel or the like, is inserted in the open end 32 of PEX tubing 30. Stiffener sleeve 34 includes an annular shoulder 36 and a cylindrical body with an outer diameter substantially conforming to the inner diameter of PEX tubing 30. FIG. 5 shows the exploded view of the components of the system in a fitting 10, such as an elbow joint, prior to assembly. The sleeve 34 is first inserted into end 32 of PEX tubing 30, as seen in FIG. 6, with the annular flange 36 holding the body of the sleeve in position in the area of the crimp. Thus, stiffener sleeve 34 is of sufficient length to span the area on opposite sides of the O-ring groove 14 where crimping occurs, as best seen in FIG. 4.

Subsequently, the end 32 of the PEX tubing 30 is fully inserted into the fitting 10, as seen in FIG. 7, and the crimp force applied circumferentially around the outer periphery of the fitting 10 on opposite sides of the bulge 15 resulting in crimps 21, 23, as in the first embodiment, to hold the PEX tubing 30 in position. The barbs 18, 22, and 24 secure the tube 30 preventing its removal while the O-ring 19 sealably completes the fluid connection of PEX conduit 30 to the fitting 10.

In place of the crimping shown in FIG. 4 for the PEX joint, other conventional fastening methods may be employed, such as crimp rings, clamps, or bands. The tube stiffener serves to prevent the collapse of the PEX tube 30 during the sealing process of the tube inserted into the fitting 10. In the crimping process for either embodiment, a conventional crimping tool is employed.

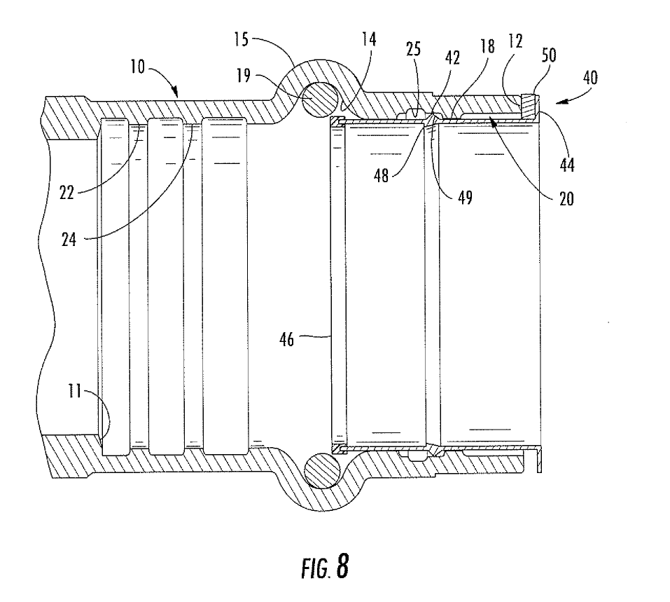

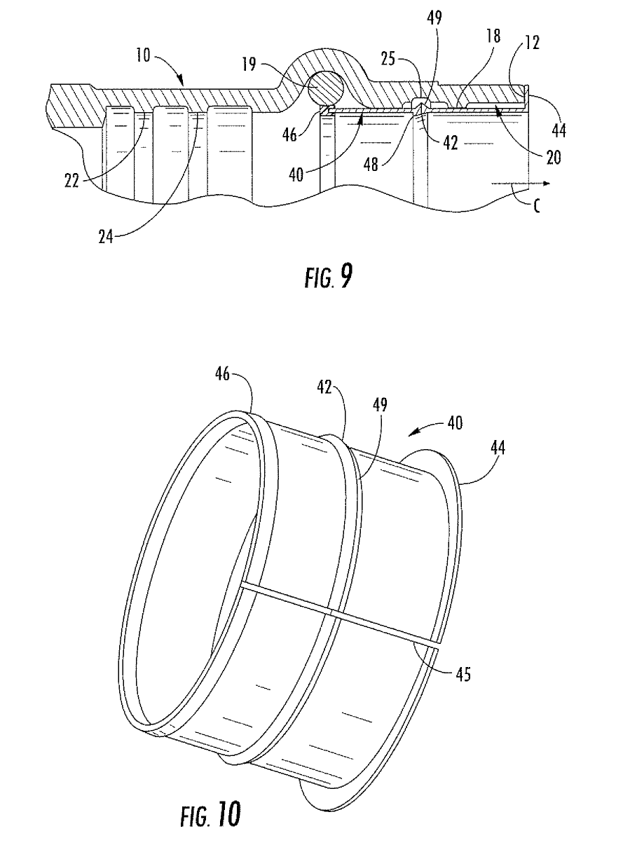

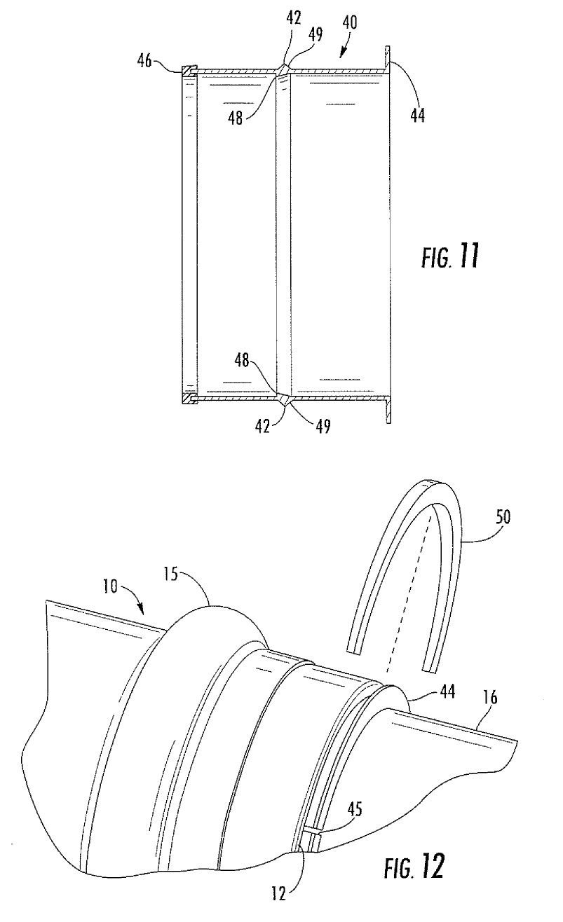

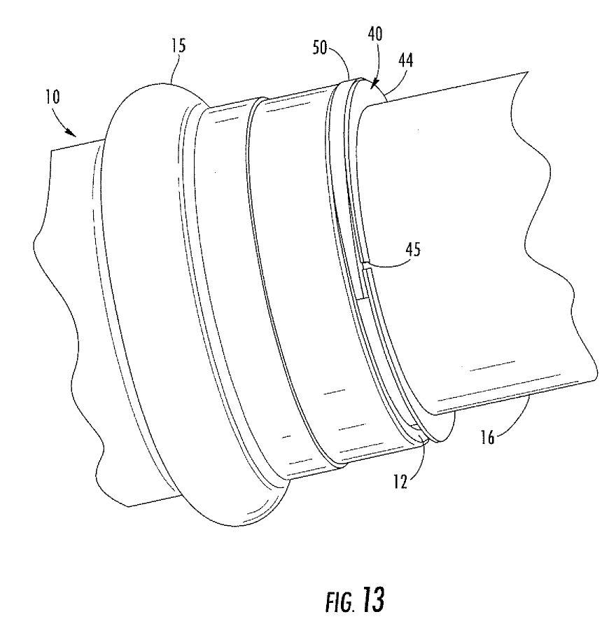

Finally, a push-type connection not requiring crimping but in which a fitting 10 with the same universal socket 20 is employed, as shown in FIGS. 8-13. Socket 20, as in the previous embodiments, includes a stepped rectangular recess 25 adjacent the annular O-ring receiving groove 14 and immediately adjacent the barb 18 to receive the radially extending annular gripping edge 42 of a cylindrical locking sleeve 40. The locking sleeve 40 is best seen in FIGS. 10 and 11 and includes an annular flange 44 at one end and an O-ring compressing tapered generally conical polymeric end 46 at the opposite end. The sleeve 40 is progressively formed from steel roll stock in a conventional forming process, such as roll forming, resulting in a longitudinally extending narrow slot 45. End 46 is over-molded (or the end of the sleeve is otherwise covered) by a polymeric material, such as PVC, on its outer surface to protect O-ring 19 when end 46 engages the O-ring, as illustrated in FIG. 9, when sleeve 40 is inserted into end 12 in a position to receive a metal conduit, such as conduit 16 shown in FIGS. 12 and 13. In this position, the gripping edge 42 extends within the stepped recess 25 for axially holding the locking sleeve 40 in position during the insertion of the conduit 16. The conduit, once inserted, engages the inside tapered leading edge of locking barb 48 of sleeve 40, which expands the split sleeve radially outwardly, as seen in FIG. 9, to hold the sleeve gripping edge 42 in recess 25. When conduit 16 is inserted within sleeve 40, the polymeric end 46 protects the O-ring 19 as the conduit is inserted until its end engages stop shoulder 11.

In order to lock the conduit 16 within fitting 10, the sleeve 40 is moved axially in a direction shown by arrow C in FIG. 9 using a semicircular tapered wedge 50 (FIGS. 12 and 13). Wedge 50 is dimensioned to precisely move the sleeve 40 to provide the desired holding force for securing conduit 16 in fitting 10. Wedge 50 is inserted between end 12 of fitting 10 and flange 44 of sleeve 40 utilizing pliers or other suitable tool for forcing the flange 44 and sleeve 40 into a position where it moves in a direction of arrow C and end 46 clears O-ring 19. The tip of locking barb 48 of sleeve 40 is forced radially inwardly by the inclined surface 49 of gripping edge 42 having stepped recess 25 and engaging barb 18 to move barb 48 radially inwardly to a gripping and locking position against the outer surface of conduit 16. The barb 48 extends circumferentially around the entire sleeve as does gripping edge 42.

Sleeve 40 is made of a suitable metal, such as stainless steel, carbon steel, or the like, to withstand the forces applied when moving sleeve 40 from a tube-insertion position, shown in FIG. 9, to a tube locking position, shown in FIG. 13. In this embodiment, although crimping is not necessary, if desired, the coupling can additionally be crimped with or without the locking sleeve in place, which also serves to protect the O-ring 19. The slot 45 of sleeve 40 serves the additional function of providing a leak path manifesting a leak in the event a proper seal is not made. If it is necessary to remove the conduit 16 from fitting 10, wedge 50 is removed and flange 44 pushed in a direction opposite arrow C to release barb 48 from the outer surface of conduit 16 and allow its removal. The axial spacing of flange 44 with respect to recess 25 assures that, as shown in FIG. 9, gripping edge 42 is centered in recess 25 when flange 44 abuts end 12 of fitting 10.

It will become apparent to those skilled in the art that various modifications to the preferred embodiment of the invention as described herein can be made without departing from the spirit or scope of the invention as defined by the appended claims.

The invention claimed is:

1. A plumbing fitting with a universal socket for receiving crimped or push-in type connections of a conduit coupled thereto comprising:
a plumbing fitting having an inlet end;
a cylindrical socket formed at said inlet end;
an O-ring receiving groove in spaced relationship to said inlet end;
at least one radially inwardly extending barb in said socket located between said groove and said inlet end; and
at least a second radially inwardly extending barb in said socket located on a side of said groove remote from said inlet end.

2. The fitting as defined in claim 1 and further including a third radially inwardly extending barb formed in said socket on a side of said second barb remote from said groove and in spaced relationship to said second barb.

3. The fitting as defined in claim 1 wherein a PEX tube is to be coupled to said fitting and further including a stiffener sleeve for inserting into and end of the PEX tubing prior to insertion into said socket.

4. The fitting as defined in claim 1 and further including a annular recess spaced from said annular groove for receiving a gripping edge of a locking sleeve therein.

5. The fitting as defined in claim 4 and further including a longitudinally split locking sleeve having a generally cylindrical body with an outwardly extending flange at one end and a conically tapered opposite end for compressing an O-ring in said annular groove when fully inserted into said socket.

6. The fitting as defined in claim 5 wherein said locking sleeve includes a radially inwardly extending annular locking barb for engaging a conduit inserted therein and a tapered external outwardly extending gripping edge for extending into said recess of said socket to hold said locking sleeve in a fully inserted position.

7. The fitting as defined in claim 6 and further including a locking wedge for insertion between said inlet end of said fitting and said flange of said locking sleeve for moving said sleeve away from said O-ring such that said tapered gripping edge forces said locking edge against a conduit inserted into said socket to secure a conduit within said fitting.

8. The fitting as defined in claim 7 wherein said opposite end of said sleeve is made of a polymeric material.

9. The fitting as defined in claim 8 wherein said wedge is tapered.

10. A plumbing fitting with a universal socket for receiving press or push type connections of a metal or polymeric conduit thereto comprising:
a plumbing fitting having an inlet end;
a cylindrical socket formed near said inlet end;
an O-ring receiving annular groove in spaced relationship to said inlet end;
at least one annular radially inwardly extending rectangular barb in said socket located between said annular groove and said inlet end;
at least a second annular radially inwardly extending rectangular barb in said socket located on a side of said groove remote from said inlet end; and
wherein said socket further includes a stepped radially outwardly extending recess adjacent said annular groove on a side proximate said inlet end.

11. The fitting as defined in claim 10 and further including a longitudinally split metal locking sleeve having a generally cylindrical body with an outwardly extending flange at one end and a conically tapered opposite end for compressing an O-ring in said annular groove when fully inserted into said socket, wherein said conically tapered end is a polymeric material over-molded onto said opposite end.

12. The fitting as defined in claim 11 wherein said locking sleeve includes a radially inwardly extending annular locking barb for engaging a conduit inserted therein and a tapered external outwardly extending gripping edge for extending into said recess of said socket to hold said locking sleeve in a fully inserted position.

13. The fitting as defined in claim 12 and further including a locking wedge for insertion between said inlet end of said fitting and said flange of said locking sleeve for moving said sleeve away from said O-ring such that said tapered gripping edge forces said locking barb against a conduit inserted into said socket to secure a conduit within said fitting.

14. The fitting as defined in claim 13 wherein said wedge is tapered.

15. The fitting as defined in claim 14 and further including a third radially inwardly extending barb formed in said socket on a side of said second barb remote from said groove and in spaced relationship to said second barb.

16. The fitting as defined in claim 10 wherein a PEX tube is to be coupled to said fitting and further including a stiffener sleeve for inserting into and end of the PEX tubing prior to insertion into said socket.

17. The fitting as defined in claim 16 and further including an O-ring fitted within said annular groove.

18. A plumbing fitting with a universal socket for receiving crimped or push-in type connections of a metal or polymeric conduit thereto comprising:
a plumbing fitting having an inlet end;
a cylindrical socket formed near said inlet end, said socket including an O-ring receiving an annular groove in spaced relationship to said inlet end;
at least one annular radially inwardly extending barb in said socket located between said annular groove and said inlet end, and at least a second annular radially inwardly extending barb in said socket located on a side of said groove remote from said inlet end, and wherein said socket further includes a stepped radially outwardly extending recess adjacent said annular groove on a side proximate said inlet end; and
a longitudinally split locking sleeve for insertion into said inlet end of said fitting to releasably lock a conduit into said fitting, said sleeve having a generally cylindrical body with an outwardly extending flange at one end and a conically tapered opposite end for compressing said O-ring in said annular groove when said sleeve is fully inserted into said socket.

19. The fitting as defined in claim 18 wherein said locking sleeve includes a radially inwardly extending annular locking barb for engaging a conduit inserted therein and a tapered external outwardly extending gripping edge for extending into said recess of said socket to hold said locking sleeve in a fully inserted position.

20. The fitting as defined in claim 19 and further including a locking wedge for insertion between said inlet end of said fitting and said flange of said locking sleeve for moving said sleeve away from said O-ring such that said tapered gripping edge forces said locking barb against a conduit inserted into said socket to secure a conduit within said fitting.

21. The fitting as defined in claim 20 wherein said wedge is tapered.

22. The fitting as defined in claim 21 wherein said sleeve is made of metal and said tapered end is a polymeric material over-molded on said opposite end of said sleeve.
